(19) United States
(12) Patent Application Publication
(10) Pub. No.: US 2011/0153790 A1
(43) Pub. Date: Jun. 23, 2011

(54) OPEN ACCESS POINT, TERMINAL AND INTERNET SERVICE PROVIDING METHOD THEREOF

(75) Inventor: Seong-Im YOON, Gyeryong (KR)

(73) Assignee: Electronics and Telecommunications Research Institute, Daejeon (KR)

(21) Appl. No.: 12/968,761

(22) Filed: Dec. 15, 2010

(30) Foreign Application Priority Data
Dec. 18, 2009 (KR) 10-2009-0127265
Oct. 18, 2010 (KR) 10-2010-0101504

(51) Int. Cl. G06F 15/177

(52) U.S. Cl. 709/221

(57) ABSTRACT

Provided is a future internet service providing method. An open access point registers information of the open access point in a reconfiguration server comprised in an internet, when the open access point accesses the Internet. The open access point registers information of a mergence node accessing the open access point, in the reconfiguration server. The open access point provides sensing information of the mergence node to a terminal, when the terminal requests the sensing information of the mergence node. A terminal requests providing of service type information to a domain name server. The terminal selects a service type for providing of internet service from among the service type list when a service type list is received from the domain name server, in response to the request. The terminal requests sensing information to an open access point capable of providing of the selected service type. The terminal provides internet service having the selected service type on the basis of the sensing information.

### CROSS-REFERENCE TO RELATED APPLICATIONS

This U.S. non-provisional patent application claims priority under 35 U.S.C. §119 of Korean Patent Application Nos. 10-2009-0127265, filed on Dec. 18, 2009, and 10-2010-0101504, filed on Oct. 18, 2010, the entire contents of which are hereby incorporated by reference.

### BACKGROUND OF THE INVENTION

The present disclosure herein relates to a network system, and more particularly, to an open access point, a terminal and an internet service providing method thereof, which provide internet service in an open network system.

Various application services are being developed in the existing internet. Therefore, application services based on a scheme, which was not considered when the existing internet was designed, are being introduced by users' requirements. Recently, research on the future internet is actively being conducted for satisfying users' requirements that are rapidly changed. The future internet is proposed for solving the fundamental limitations of the existing internet.

Furthermore, research is actively being conducted for implementing the future internet in a network system. The future internet requires a network system having a flexible structure for providing various application services.

### SUMMARY OF THE INVENTION

The present disclosure provides an internet service providing method which is required by users in the future internet environment.

Embodiments of the present invention provide an open access point including: a node sensor sensing a mergence node; a resource management unit managing information of a unit network which includes the sensed mergence node; a profile unit registering the information of the unit network in a reconfiguration server when accessing an internet; and a sensing information processor providing sensing information, which is received from the mergence node, to a terminal when the terminal requests the sensing information of the unit network.

In some embodiments, the profile unit may access the internet in a plug and play scheme for allowing the reconfiguration server to automatically recognize the open access point.

In other embodiments, the information of the unit network may include information of the open access point, and information of a mergence node accessing the open access point.

In still other embodiments, the sensing information may include at least one of a sensing value which is obtained by measuring surrounding factors through a sensor included in the mergence node and operation information of the sensor.

In other embodiments of the present invention, a terminal includes: a service type request unit requesting service type information to a domain name server, and receiving a service type list corresponding to the service type request from the domain name server; a user input unit receiving a user selection signal for selecting a service type from among the service type list; an internet service request unit requesting sensing information to an open access point having a service type which corresponds to the user selection signal; and an internet service driver receiving sensing information from the open access point and providing internet service on the basis of the sensing information, according to the sensing information request.

In some embodiments, the service type list may include a service type of each of open access points, and an address for accessing the each open access point.

In still other embodiments of the present invention, an internet service providing method of an open access point includes: registering information of the open access point in a reconfiguration server included in an internet, when the open access point accesses the internet; registering information of a mergence node accessing the open access point, in the reconfiguration server; and providing sensing information of the mergence node to a terminal, when the terminal requests the sensing information of the mergence node.

In some embodiments, the registering of information of the open access point may include: accessing the internet in a plug and play scheme for allowing the reconfiguration server to automatically recognize the open access point, and registering the information of the open access point in the reconfiguration server.

In other embodiments, the registering of information of the open access point may include: registering the information of the open access point in the reconfiguration server by using unique address information of the open access point.

In still other embodiments, the registering information of a mergence node may include: registering the mergence node in the reconfiguration server by using at least one of an address and name of the mergence node.

In even other embodiments, the sensing information may include at least one of a sensing value, which is obtained by measuring surrounding factors through a sensor included in the mergence node, and operation information of the sensor.

In yet other embodiments, the internet service providing method may further include: updating the information of the mergence node in a sensing table, and transmitting the updated sensing table to the reconfiguration server to register the newly-registered mergence node, when a new-registration-requested mergence nod exists in the open access point.

In further embodiments, the internet service providing method may further include: configuring one unit network which includes the open access point and mergence nodes accessing the open access point.

In even other embodiments of the present invention, an internet service providing method of a terminal includes: requesting providing of service type information to a domain name server; selecting a service type for providing of internet service from among the service type list when a service type list is received from the domain name server, in response to the request; requesting sensing information to an open access point capable of providing of the selected service type; and providing internet service having the selected service type on the basis of the sensing information.

In some embodiments, the service type list may include a service type of each of open access points, and an address for accessing the each open access point.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram illustrating a structure of an open network system using the future internet, according to an embodiment of the present invention;

FIG. 2 is a diagram exemplarily illustrating a structure of the mergence node of FIG. 1;

FIG. 3 is a diagram exemplarily illustrating a structure of an open access point which is exemplarily illustrated in FIG. 1;

FIG. 4 is a diagram exemplarily illustrating a structure of a reconfiguration server which is illustrated in FIG. 1;

FIG. 5 is a diagram exemplarily illustrating a structure of a terminal which is illustrated in FIG. 1;

FIG. 6 is a flowchart illustrating a method of providing future internet service in the open network system of FIG. 1;

FIG. 7 is a flowchart illustrating an operation of registering an open access point in FIG. 6;

FIG. 8 is a flowchart illustrating an operation of registering a mergence node in FIG. 6; and

FIG. 9 is a flowchart illustrating an operation of providing sensing information in FIG. 6.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Also, in the following description, only elements necessary for understanding operations according to embodiments of the inventive concept will be described, and the description of other elements will be omitted in order not to unnecessarily obscure subject matters of the inventive concept.

Due to wired/wireless integration, the future internet provides an environment that enables users to stably use the future internet service having high quality anywhere at any time. Also, the future internet autonomously provides service necessary for users, and thus can provide various future intelligent internet services. Therefore, future internet service denotes service in which all users can easily search desired content over the future internet anywhere at any time.

Unlike a typical access point, an open access point according to an embodiment of the present invention may access the future internet and provide service based on sensing information that is sensed from lower nodes.

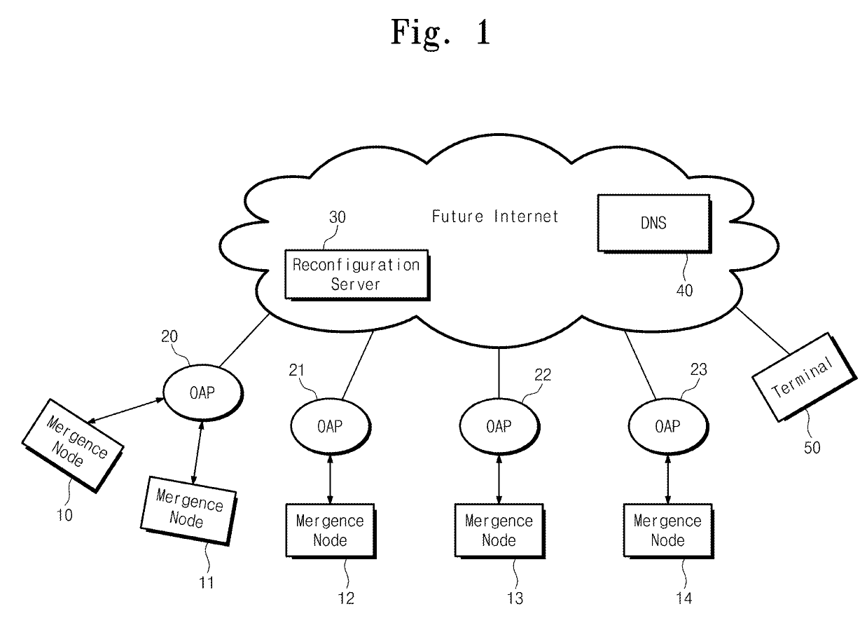

FIG. 1 is a diagram illustrating a structure of an open network system using the future internet, according to an embodiment of the present invention.

Referring to FIG. 1, an open network system according to an embodiment of the present invention includes mergence nodes 10 to 14, Open Access Points (OAPs) 20 to 23, a reconfiguration server 30, and a Domain Name Server (DNS) 40.

The reconfiguration server 30 and the domain name server 40 are included in the future internet.

As an example, a network system structure will be described below with respect to the mergence node 10 and the open access point 20.

The mergence node 10 autonomously senses an ambient environment to recognize surrounding factors. That is, the mergence node 10 senses an ambient environment to collect sensing information. The mergence node 10 may be implemented in various sizes according to a sensing environment. The mergence node 10 may include various sensors, and collect various sensing information by the sensors included in it or a sensing function.

The open access point 20 may be organically connected to the future internet in a plug and play scheme. The plug and play scheme is a scheme that allows the future internet to autonomously recognize the open access point 20 when the open access point 20 accesses the future internet.

When the open access point 20 accesses the future internet, it configures a unit network. Herein, the unit network includes the open access point 20, and the mergence nodes 10 and 11 accessing the open access point 20. The unit network is one network unit that is classified for providing sensing information that is sensed from the mergence nodes 10 and 11. The unit network has a service type corresponding to sensing information. The service type denotes the type of future internet service that may be provided in the unit network based on the open access point 20.

For example, if the sensing information of the mergence node 10 is the blood pressure information of a person (A) and the sensing information of the mergence node 11 is the pulse information of the person (A), the service type may be the body of the person (A). Also, the unit network may be the body network of the person (A). Furthermore, the open access point 20 may additionally access a mergence node sensing the temperature information of the person (A) and a mergence node sensing the blood sugar information of the person (A).

As an example, the unit network may be variously configured as a traffic network, a digital network, a home network, a hospital network, an enterprise network, a school network, a distribution network, etc.

The open access point 10 may perform plug and play access, and thus may set various unit networks in consideration of the surrounding factors of the open access point 20.

The reconfiguration server 30 is a server based on the future internet. The reconfiguration server 30 may manage the open access point 20 or the unit network. The reconfiguration server 30 integrates and manages unit networks that are respectively configured from the open access points 20 to 23. For this, the reconfiguration server 30 manages a sensing table including information on the unit networks.

As an example, the sensing table is configured based on the service type of the open access point 20 with respect to a unit network including the open access point 20. The sensing table includes information (for example, an address or a service type) of the open access point 20, and information (for example, an address, a name and a sensing state (current operation state of a sensor)) of mergence nodes accessing the open access point 20.

When information on the service type of the open access point 20 that is newly registered does not internally exist, the reconfiguration server 30 may acquire information of a corresponding service type from the future internet.

The domain name server 40 is a server that changes a domain or host name to an address in the future internet and provides the changed address. The address in the future internet may use various address systems including Transmission Control Protocol/internet Protocol (TCP/IP). The domain name server 40 may support all the address systems based on the future internet. The domain name server 40 stores information of the open access point 20 that is newly accessed. The domain name server 40 may provide information of the open access point 20 when the same unit network is configured later.

A terminal 50 may request or receive future internet service, and provide the future internet service (for example, future internet service based on sensing information) to a user. When a unit network that is configured based on the service type of the open access point 20 is selected, the terminal 50 may receive various sensing information from the selected unit network.

The reconfiguration server 30 and the domain name server 40 may be included in the future internet.

The present invention configures a unit network through an open access point accessing the future internet. The unit network generates a plurality of sensing information. Therefore, the present invention provides the sensing information of a unit network required by a user to the terminal 50, and thus provides future internet service based on the sensing information.

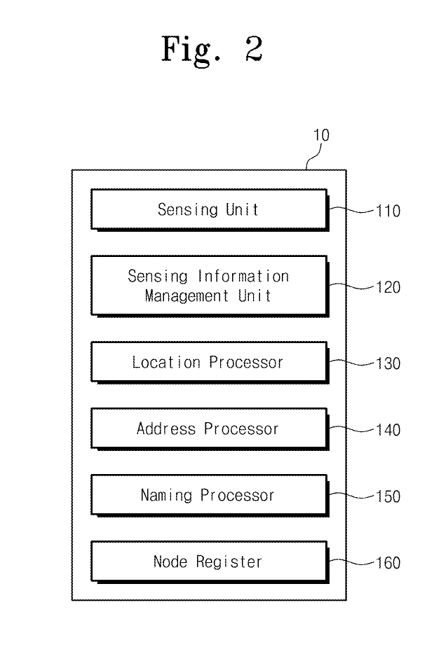

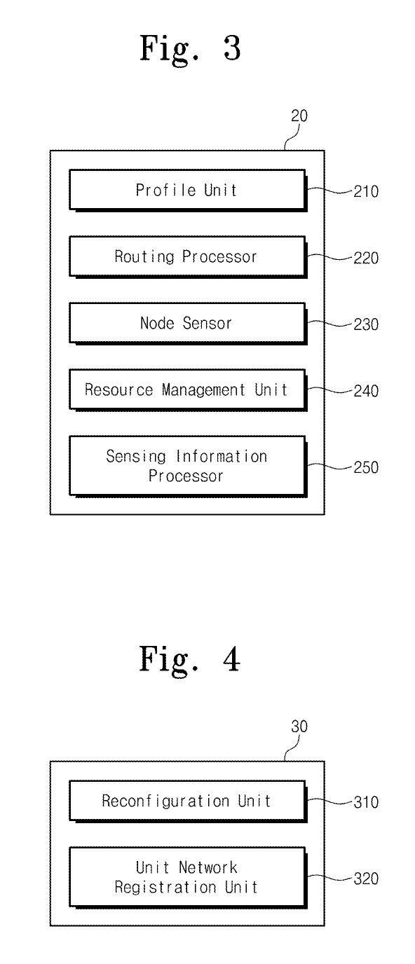

The structure of the mergence node will be described below with reference to FIG. 2. The operation of the open access point will be described below with reference to FIG. 3. The operation of the reconfiguration server will be described below with reference to FIG. 4. The operation of an open network system providing future internet service according to an embodiment of the present invention will be described below with reference to FIG. 6.

FIG. 2 is a diagram exemplarily illustrating a structure of the mergence node of FIG. 1.

Referring to FIG. 2, the mergence node 10 includes a sensing unit 110, a sensing information management unit 120, a location processor 130, an address processor 140, a naming processor 150, an access point sensor 160, and a node register 170.

The sensing unit 110 has a Radio Frequency IDentification (RFID) function and a sensor function. As a sensor, various kinds of sensors may be used.

The sensing unit 110 includes a sensor that acquires tag information by an RFID function. The sensing unit 110 generates a sensing value for an ambient environment through a sensor. Also, the sensing unit 110 may sense an access point to communicate.

The sensing information management unit 120 manages sensing information. The sensing information includes at least one of the sensing value and operation information of a sensor. The sensing information management unit 120 may acquire the operation state (for example, an idle state, an active state, an inactive state, an abnormal state, etc) of the sensor for acquiring the operation information of the sensor.

When the open access point 20 requests sensing information, the sensing information management unit 120 transmits sensing information to the open access point 20. Also, the sensing information management unit 120 may manage a service type, which corresponds to measured sensing information, in correspondence with the sensing information.

The location processor 130 collects and manages future internet-based location information associated with the movement of the mergence node 10. The location processor 130 may provide location information by the location information request of the open access point 20 or the like.

The address processor 140 processes future internet-based address (for example, similar to a current internet Protocol (IP)). An address processed by the address processor 140 is a physical address.

The naming processor 150 processes (discovers) future internet-based name information by a specific user or service. A name processed by the naming processor 150 is a logical address. Name information, for example, may be a service type (for example, blood pressure, pulse, temperature, blood sugar, etc in the body of Gil-dong Hong).

When the sensing unit 10 senses the open access point 20, the node register 160 may request the registration of the mergence node 10 to the future internet over the open access point 20. Upon registration request of the mergence node 10, the node register 160 may request registration using at least one of the location information, address information and name information of the mergence node 10.

When the mergence node 10 operates by a self-power, the mergence node 10 may additionally include a battery (not shown).

FIG. 3 is a diagram exemplarily illustrating a structure of the open access point which is exemplarily illustrated in FIG. 1.

Referring to FIG. 3, the open access point 20 includes a profile unit 210, a routing processor 220, a node sensor 230, a resource management unit 240, and a sensing information processor 250.

The profile unit 210 accesses the open network system, i.e., the future internet through the plug and play scheme upon initial access. The profile unit 210 may organically connect the open access point 20 to the future internet through the plug and play scheme.

The profile unit 210 sets the service type of the open access point 20 in order to support a service type suitable for the function of the open access point 20. The profile unit 210 may consider the sensing information of mergence nodes accessible to the open access point 20 for setting of a service type. The open access point 20 configures a unit network according to the service type that is set by the profile unit 210. For configuring the unit network, the profile unit 210 may use at least one address (for example, unique address of an open access point) that will be used at an initial environment for receiving sensing information. The profile unit 210 may transmit the address to the reconfiguration server 30 and store information on the open access point 20 and the unit network configured with the open access point 20. The information of the unit network includes the information of the open access point 20 and information on a mergence node accessing the open access point 20.

The routing processor 220 performs a routing operation for a mergence node accessing the open access point 20 according to a future internet user or future internet service request.

The node sensor 230 has the function of a general sensor, and senses at least one mergence node 10 for communicating with the open access point 20.

The resource management unit 240 manages resource information, which includes information on mergence nodes accessing the open access point 20. The resource management unit 240 manages resource information such as the total number of mergence nodes, the operation state of the sensor of a mergence node or sensing information measured by the mergence node. The resource management unit 240 may manage information on a unit network, which includes the open access point 20 and mergence nodes communicating with the open access point 20, with a sensing table.

When the terminal of the future internet requests sensing information on a unit network, the sensing information processor 250 receives the sensing information from the mergence node 10 and provides the sensing information to the terminal

FIG. 4 is a diagram exemplarily illustrating a structure of the reconfiguration server which is illustrated in FIG. 1.

Referring to FIG. 4, the reconfiguration server 30 includes a reconfiguration unit 310 and a unit network registration unit 320.

The reconfiguration unit 310 acquires the service type of a unit network configured with the open access point 20, and manages a unit network based on the open access point 20 according to a service type. For managing the unit network, the reconfiguration unit 310 may manage a sensing table. The sensing table managed by the reconfiguration unit 310 includes information (for example, the service type of the unit network (open access point or mergence node), the address of an open access point, the address of a mergence node, a mergence node accessing the open access point and the number of mergence nodes accessing the open access point) on the unit network.

The unit network register 320 registers information of the unit network in the domain name server 40. Also, the unit network register 320 may provide the updated information of the unit network to the domain name server 40.

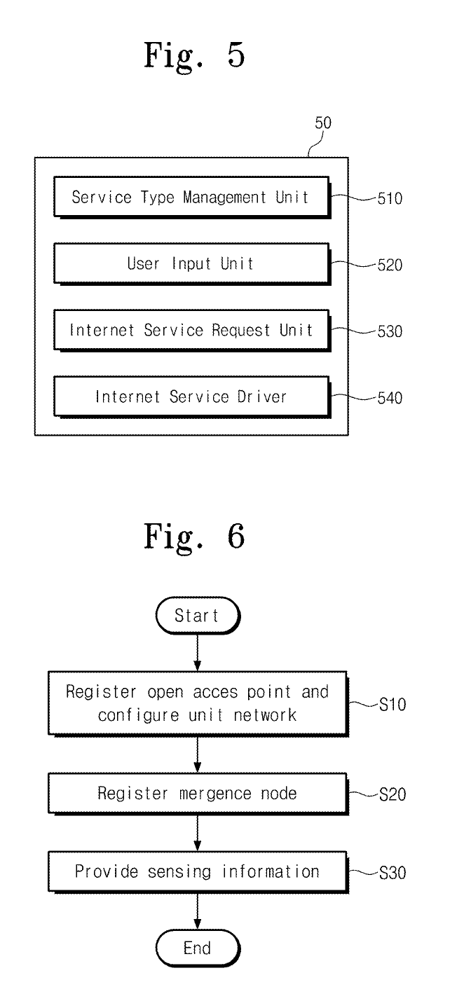

FIG. 5 is a diagram exemplarily illustrating a structure of the terminal which is illustrated in FIG. 1.

Referring to FIG. 5, the terminal 50 includes a service type management unit 510, a user input unit 520, an internet service request unit 530, and an internet service driver 540.

The service type management unit 510 requests service type information to the domain name server 40 of the internet. The service type management unit 510 receives a service type list including the service type information from the domain name server 40.

The user input unit 520 interfaces with a user. For this, the user input unit 520 may include a user input device such as a keypad or a touch pad. The user input unit 520 generates a selection signal according to the user's selection, wherein the selection signal is for selecting a service type for reception of internet service from among a service type list.

The internet service request unit 530 requests sensing information to the open access point 20 having a service type which corresponds to the selection signal. Herein, the open access point 20 configures a unit network according to a service type, and collects various sensing information from the unit network. The internet service request unit 530 may receive sensing information collected from the open access point 20.

The internet service driver 540 receives sensing information from the open access point 20 according to a sensing information request. The internet service driver 540 provides internet service to the user on the basis of the received sensing information.

FIG. 6 is a flowchart illustrating a method of providing future internet service in the open network system of FIG. 1.

Referring to FIG. 6, the open network system registers an open access point in operation S10.

The open network system registers a mergence node accessing the open access point in operation S20.

The open network system provides sensing information, which is requested by a user, from a unit network to a terminal in operation S30. The unit network includes the open access point and the mergence node accessing the open access point.

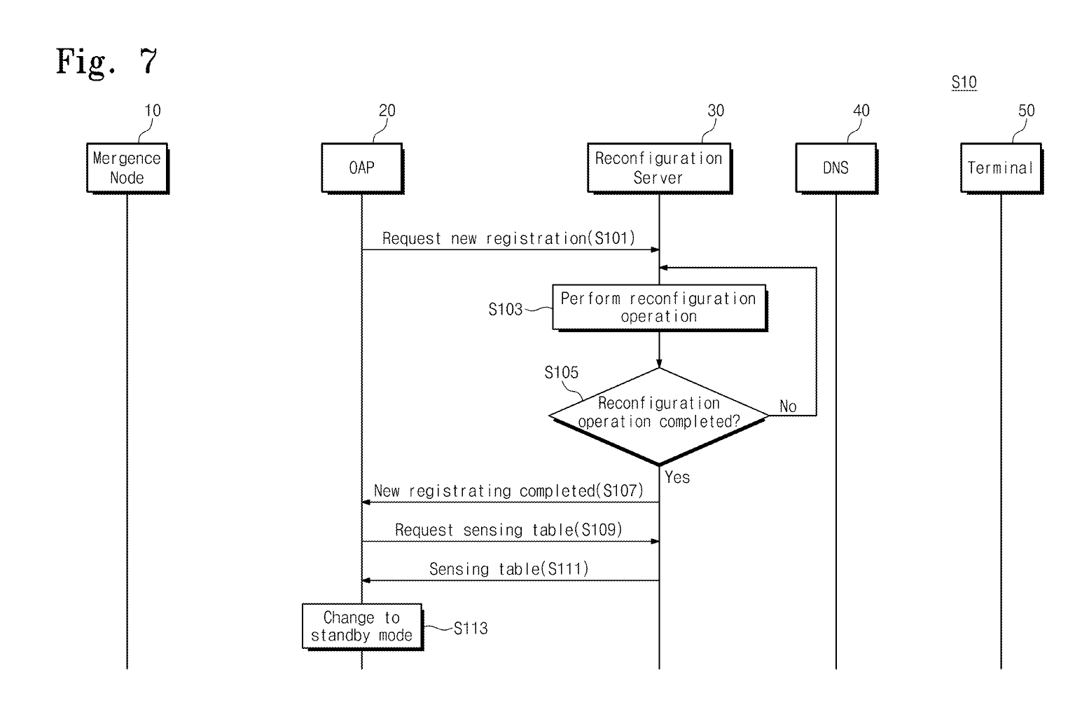

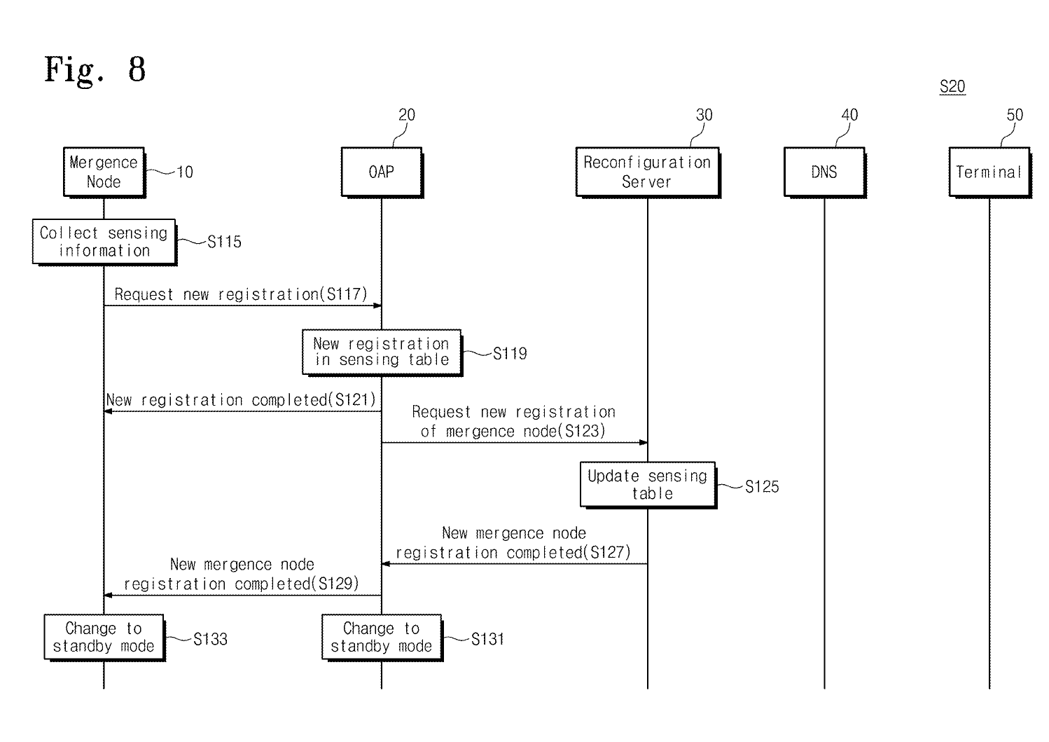

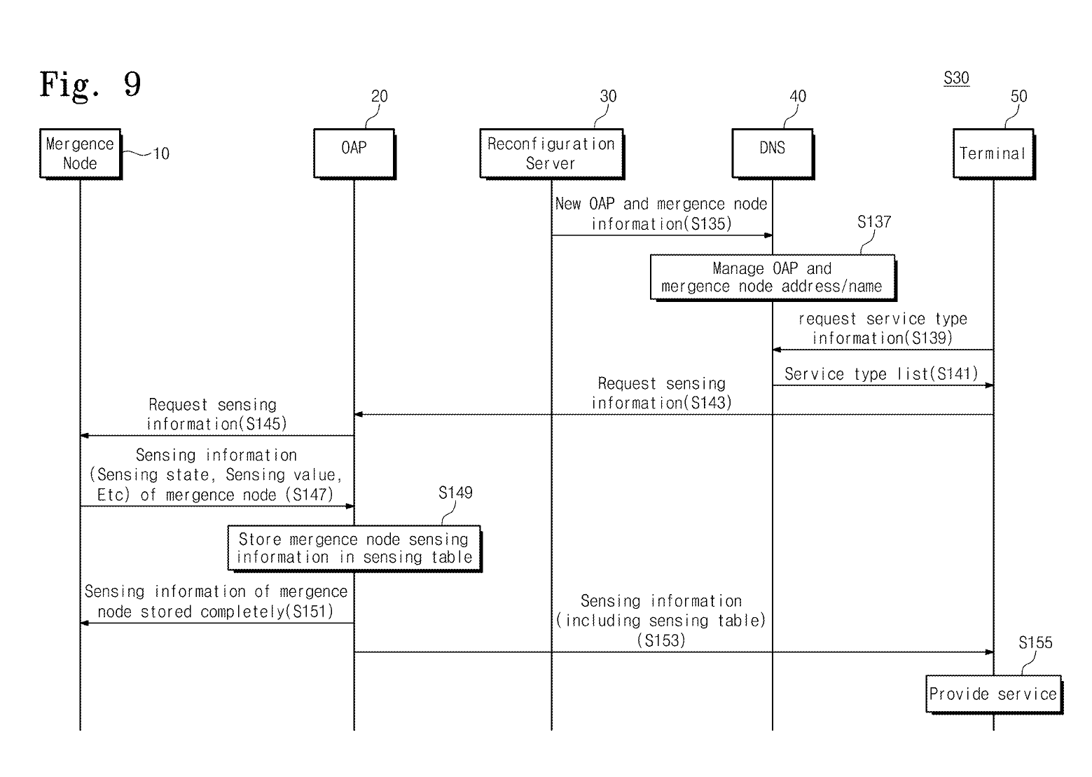

Operation S10 of FIG. 6 will be described in detail below with reference to FIG. 7. Operation S20 of FIG. 6 will be described in detail below with reference to FIG. 8. Operation S30 of FIG. 6 will be described in detail below with reference to FIG. 9.

FIG. 7 is a flowchart illustrating an operation of registering the open access point in FIG. 6.

Referring to FIG. 7, the open access point 20 requests new registration to the reconfiguration server 30 in operation S110. Upon request of new registration, the open access point 20 transmits information on its own address and service type to the reconfiguration server 30. At this point, when initially accessing the future internet, the open access point 20 may set a service type for configuring of a unit network through a plug and play operation.

The reconfiguration server 30 performs reconfiguration in operation S 103. Herein, the reconfiguration operation denotes an operation that newly registers the open access point 20 in the sensing table of the reconfiguration server 30. The reconfiguration server 30 checks whether information on a new-registration-requested service type exists in the open access point 20. When the new-registration-requested service type exists, the reconfiguration server 30 registers the open access point 20 that is not included in the sensing table. When the new-registration-requested service type does not exist, the reconfiguration server 30 acquires information of a corresponding service type from the future internet, and registers the open access point 20 in the sensing table. When the new registration request of another open access point is received by the reconfiguration server 30 during the reconfiguration operation of the open access point 20, the new registration request of the other open access point is in a standby state. Also, when the new registration request of the open access point 20 is received by the reconfiguration server 30 during the reconfiguration operation of the other open access point, the new registration request of the open access point 20 is in a standby state.

The reconfiguration server 30 checks whether the reconfiguration operation is completed in operation S105. That is, the reconfiguration server 30 checks whether the new registration of the new-registration-requested open access point 20 is completed. When the reconfiguration operation is not completed as the checked result of operation S105, an operation proceeds to operation S103.

When the reconfiguration operation is completed as the checked result of operation S105, an operation proceeds to operation S107.

The reconfiguration server 30 notifies the open access point 20 of new registration completion in operation S107. Through the new registration completion of the reconfiguration server 30, the open access point 20 may configure a unit network.

The open access point 20 requests a sensing table to the reconfiguration server 30 in operation S109.

The reconfiguration server 30 transmits the sensing table to the open access point 20 in operation S111.

The open access point 20 changes a mode to a standby mode when the sensing table is received in operation S113.

FIG. 8 is a flowchart illustrating an operation of registering the mergence node in FIG. 6.

Referring to FIG. 8, the mergence node 10 collects sensing information in operation S115. The mergence node 10 may sense an ambient environment and collect sensing information of surrounding factors.

When the mergence node 10 recognizes the peripheral open access point 20, it requests new registration to the open access point 20 in operation S117. Upon request of new registration, the mergence node 10 transmits at least one of its own address information, location information and name information to the reconfiguration server 30.

In operation S119, the open access point 20 stores information of the new-registration-requested mergence node 10 in the sensing table. The open access point 20 may select only a mergence node corresponding to its own service type and store the selected node in the sensing table.

In operation S121, the open access point 20 transmits new registration completion to the mergence node 10 when the new registration of the mergence node 10 is completed in the sensing table.

In operation S123, the open access point 20 transmits the newly-updated sensing table information, for example, information (address, service type, etc) of the newly-registered mergence node 10 to the reconfiguration server 20 and requests the registration of the new mergence node 10.

In operation S125, the reconfiguration server 30 updates the newly-updated sensing table information (for example, information of the new mergence node 10) in a stored sensing table. The sensing table may store information (for example, open access points 20) configuring a unit network, and information of the mergence nodes 11 and 12 accessing the open access point 20.

In operation S127, the reconfiguration server 30 transmits new mergence node registration completion to the open access point 20.

In operation S129, the open access point 20 transmits new mergence node registration completion, indicating that the new mergence node has completely been registered in the reconfiguration server 30, to the new mergence node 10.

In operation S131, the open access point 20 changes a current mode to a standby mode.

In operation S133, the mergence node 10 changes a current mode to the standby mode when new mergence node registration completion in the reconfiguration server 30 is received.

FIG. 9 is a flowchart illustrating an operation of providing sensing information in FIG. 6.

Referring to FIG. 9, the reconfiguration server 30 transmits information (for example, address, service type, etc) on newly-registered open access points and newly-registered mergence nodes to the domain name server 40 in operation S135. At this point, the reconfiguration server 30 may transmit information of the open access point 20 and mergence node 10 acquired through sensing table update, to the domain name server 40. As an example, the reconfiguration server 30 may acquire the information of the open access point 20 and mergence node 10 that are newly registered through the operations of FIGS. 8 and 9.

In operation S137, the domain name server 40 manages the address or name of the open access point 20, and manages the address or name of the mergence node 10.

In operation S139, the terminal 50 requests the service type information of the open access points to the domain name server 40. Herein, the terminal 50 is a user terminal. The terminal 50 requests service type information to the domain name server 40, for providing a list of unit networks configured with the open access points to the user.

In operation S141, the domain name server 40 transmits a service type list including the service type information of the open access points to the terminal 50. The service type list includes service types provided from the respective open access points, and addresses for accessing the respective open access points. Herein, the address of the open access point denotes a network address. As an example, the address may include an IP.

In operation S143, the terminal 50 requests sensing information to a corresponding open access point 20, for receiving service based on a service type that is selected on the basis of the service type list.

In operation S145, the open access point 20 requests sensing information to the mergence node 10.

In operation S147, the mergence node 10 transmits sensing information to the open access point 20. The sensing information includes the current sensing state of a sensor and a sensing value measured by the sensor. When the sensing information is requested, the mergence node 10 may provide previously-measured sensing information to the open access point 20, and provide newly-measured sensing information to the open access point 20 in response to a sensing information request.

In operation S149, the open access point 20 stores the sensing information of the mergence node 10 in the sensing table.

In operation S151, the open access point 20 transmits the storage completion of the sensing information to the mergence node 10. The open access point 20 may store the sensing information of mergence node 10 and the sensing information of other mergence nodes.

In operation S153, the open access point 20 transmits sensing information to a mobile terminal At this point, the open access point 20 may transmit a sensing table including the sensing information to the terminal 50.

In operation S155, the terminal 50 may receive service corresponding to a service type requested by it.

As an example, when the terminal 50 selects a service type associated with its body, it may acquire sensing information such as blood pressure, pulse, temperature and blood sugar from an open access point 20 configuring a body-related unit network. At this point, the open access point 20 may receive sensing information from a mergence node measuring blood pressure, a mergence node measuring pulse, a mergence node measuring temperature and a mergence node measuring blood sugar. The open access point 20 may provide the received sensing information (for example, blood pressure, pulse, temperature and blood sugar) to the terminal 50.

In the above-referenced drawings, the above description has been focused on the one mergence node 10 and the one open access point 20, but the other mergence nodes 11 to 14 and the other open access points 21 to 23 may perform similar functions, respectively. Moreover, the one open access point 20 may access one or more mergence nodes, for acquiring various sensing information.

In FIGS. 7 to 9, the open network system provides sensing information, which is acquired in a unit network through the configuration of the unit network, to the terminal, i.e., the user terminal

The open access point according to an embodiment of the present invention may configure the structure of a network system in an open type (i.e., configure a unit network based on a service type). Accordingly, when the future internet is applied to the open access point according to an embodiment of the present invention, service requested by future internet service can be provided.

Therefore, a terminal accessing the future internet can receive various sensing information from a unit network (i.e., an open access point) that may provide future internet service based on a desired service type, according to a user's request.

The open network system according to embodiments of the present invention can provide internet service that is required by users in the internet environment. Moreover, the open network system according to embodiments of the present invention allows the mergence nodes having the sensing function to be connected to the internet through the open access point, thereby providing various internet services required by users.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An open access point comprising:
a node sensor sensing a mergence node;
a resource management unit managing information of a unit network which comprises the sensed mergence node;
a profile unit registering the information of the unit network in a reconfiguration server when accessing an internet; and
a sensing information processor providing sensing information, which is received from the mergence node, to a terminal when the terminal requests the sensing information of the unit network.

2. The open access point of claim 1, wherein the profile unit accesses the internet in a plug and play scheme for allowing the reconfiguration server to automatically recognize the open access point.

3. The open access point of claim 1, wherein the information of the unit network comprises information of the open access point, and information of a mergence node accessing the open access point.

4. The open access point of claim 1, wherein the sensing information comprises at least one of a sensing value which is obtained by measuring surrounding factors through a sensor comprised in the mergence node and operation information of the sensor.

5. A terminal comprising:
a service type request unit requesting service type information to a domain name server, and receiving a service type list corresponding to the service type request from the domain name server;
a user input unit receiving a user selection signal for selecting a service type from among the service type list;
an internet service request unit requesting sensing information to an open access point having a service type which corresponds to the user selection signal; and
an internet service driver receiving sensing information from the open access point and providing internet service on the basis of the sensing information, according to the sensing information request.

6. The terminal of claim 5, wherein the service type list comprises a service type of each of open access points, and an address for accessing the each open access point.

7. An internet service providing method of an open access point, the internet service providing method comprising:
registering information of the open access point in a reconfiguration server comprised in an internet, when the open access point accesses the internet;
registering information of a mergence node accessing the open access point, in the reconfiguration server; and
providing sensing information of the mergence node to a terminal, when the terminal requests the sensing information of the mergence node.

8. The internet service providing method of claim 7, wherein the registering of information of the open access point comprises: accessing the internet in a plug and play scheme for allowing the reconfiguration server to automatically recognize the open access point, and registering the information of the open access point in the reconfiguration server.

9. The internet service providing method of claim 7, wherein the registering of information of the open access point comprises: registering the information of the open access point in the reconfiguration server by using unique address information of the open access point.

10. The internet service providing method of claim 9, wherein the registering information of a mergence node comprises: registering the mergence node in the reconfiguration server by using at least one of an address and name of the mergence node.

11. The internet service providing method of claim 9, wherein the sensing information comprises at least one of a sensing value, which is obtained by measuring surrounding factors through a sensor comprised in the mergence node, and operation information of the sensor.

12. The internet service providing method of claim 9, further comprising:
updating the information of the mergence node in a sensing table, and transmitting the updated sensing table to the reconfiguration server to register the newly-registered mergence node, when a new-registration-requested mergence nod exists in the open access point.

13. The internet service providing method of claim 9, further comprising:
configuring one unit network which comprises the open access point and mergence nodes accessing the open access point.

14. An internet service providing method of a terminal, the internet service providing method comprising:
requesting providing of service type information to a domain name server;
selecting a service type for providing of internet service from among the service type list when a service type list is received from the domain name server, in response to the request;
requesting sensing information to an open access point capable of providing of the selected service type; and
providing internet service having the selected service type on the basis of the sensing information.

15. The internet service providing method of claim 14, wherein the service type list comprises a service type of each of open access points, and an address for accessing the each open access point.
